(19) United States
(12) Patent Application Publication
(10) Pub. No.: US 2016/0275875 A1
(43) Pub. Date: Sep. 22, 2016

(54) DISPLAY SYSTEM AND CONTROL METHOD THEREOF

(71) Applicant: Boe Technology Group Co., Ltd., Beijing (CN)

(72) Inventor: Wei Wei, Beijing (CN)

(21) Appl. No.: 14/744,146

(22) Filed: Jun. 19, 2015

(30) Foreign Application Priority Data
Mar. 20, 2015 (CN) 201510125515.9

(51) Int. Cl. G09G 3/34; G02F 1/1335; G09G 3/36; G02F 1/1343

(52) U.S. Cl. CPC G09G 3/3406; G02F 1/134309; G02F 1/13439; G02F 1/133512; G09G 3/3696; G09G 2358/00; G09G 2320/08; G09G 2320/0686; G09G 2320/0626

(57) ABSTRACT

Systems and methods for adjusting the direction of emitted light that passes through a liquid crystal cell. The light can then only be viewed in a determined region, which prevents objects in other regions from peeping. The system includes an image capture device that acquires an image in front of the display unit and transmits the image to a liquid crystal cell control module. The liquid crystal cell control module recognizes a predetermined human face in the image, determines a particular region where the predetermined human face is located based on a position of the human face in the image, and outputs a control signal to the liquid crystal cell based on the particular region. The liquid crystal cell controls light from the display panel that passes through the liquid crystal cell based on the control signal, so as to enable the light to be emitted to the particular region.

### RELATED APPLICATIONS

The present application claims the benefit of Chinese Patent Application No. 201510125515.9, filed Mar. 20, 2015, the entire disclosure of which is incorporated herein by reference.

### FIELD OF THE INVENTION

The present invention relates to the technical field of privacy of visual displays.

### BACKGROUND OF THE INVENTION

Due to growing popularity of electronic information devices, people increasingly rely on electronic information devices in more and more aspects of daily life. However, in order to protect privacy of information from being viewed by others, people have also been paying more attention to information security. For example, various anti-view devices are used in the electronic information device industry. In some earlier anti-view technologies, the anti-view devices were an anti-view film attached to the surface of an electronic screen to achieve anti-view function. The user would attach the anti-view film to the screen in an environment where other people is present, so as to prevent others around the user from viewing the information on the screen. However, when the user would like to use the electronic information device with the anti-view film attached, the user would have to remove the anti-view film to appreciate the full quality and performance of the screen display. Such a manner of attaching and removing the anti-view film continuously would result in great inconvenience and trouble to the user.

At present, the more advanced anti-view display technologies mostly use the modes of view occlusion, grating shielding, narrow view polarizing film, and carrying auxiliary devices (such as glasses) to prevent peep. However, they also have corresponding shortcomings.

Physical occlusion, grating shielding, and narrow view polarizing film may influence freedom degree of the viewing. For example, a grating shielding anti-view device may include a plate-like base body, a transparent cover plate located above the plate-like base body, and a plurality of grating barrier walls located between the plate-like base body and the transparent cover plate, wherein the respective grating barrier walls are arranged standing on a face of the plate-like base body facing the transparent cover plate, the respective grating barrier walls are arranged in a row and are set at intervals, the respective grating barrier walls are parallel with one another; one end of each of the grating barrier walls is flexibly connected with the plate-like base body respectively, the other end is connected with the transparent cover plate respectively; the respective grating barrier walls can be deflected synchronously under the drive of the transparent cover plate. However, the above anti-view modes are not sufficient to prevent others from viewing the screen in the same direction as the intended viewer.

Auxiliary devices, for example, may include polarizing film fixed glasses and polarizing film portable glasses. Specifically, the anti-view display device may comprise: a single polarizing plate display device, the single polarizing plate display device comprising: a backlight module for generating a light source; a first polarizing plate for polarizing the light source to foam a first polarized light with a first polarizing direction; and a liquid crystal module for changing the arrangement of the liquid crystal molecules when applying an electric field, so as to adjust the rotation angle of the first polarized light to form a second polarized light with a second polarizing direction for display; and a portable polarizing device, the portable polarizing device comprising: a support bracket, the support bracket having a rotation element; and at least one second polarizing plate for being arranged on the support bracket and jointed with the rotation element, such that the second polarizing plate is rotation simultaneously when the rotation element rotates so as to receive the second polarized light of the second polarizing direction thereby identifying the display content. By taking off the portable polarizing device of the display device and placing it in front of the human eyes for viewing, those without the polarizing film can be prevented from viewing the display content. However, others carry a polarizing film can still view it from various angles at any time.

### SUMMARY OF THE INVENTION

The technical problem to be solved by the embodiments of the present invention is enabling only particular objects to view a display image while preventing others from peeping.

In order to achieve the above object, the embodiments of the present invention provide a display system and a control method thereof.

In one aspect, the embodiment of the present invention provides a display system, comprising:

a display unit, the display unit comprising: a display panel, a liquid crystal cell arranged in light exit direction of the display panel and a liquid crystal cell control module;

an image capture device, the image capture device acquiring an image in front of the display unit and transmitting the image to the liquid crystal cell control module,

the liquid crystal cell control module recognizes a predetermined human face in the image, determines a particular region where the predetermined human face locates based on a position of the predetermined human face in the image, and outputs a control signal to the liquid crystal cell based on the particular region, the liquid crystal cell controls light from the display panel that passes through the liquid crystal cell based on the control signal, so as to enable the light to be emitted to the particular region.

Further, the liquid crystal cell comprises:

a first substrate, a second substrate and a liquid crystal layer located between the first substrate and the second substrate;

the liquid crystal layer comprises a plurality of liquid crystal deflection regions, liquid crystal molecules of each liquid crystal deflection region are deflected based on the control signal in display, and the liquid crystal molecules of adjacent liquid crystal deflection regions are deflected in different angles, thereby enabling the light that passes through each liquid crystal deflection region to be emitted to the particular region.

Further, the liquid crystal cell further comprises: a plurality of electrodes arranged on the first substrate and/or the second substrate, the plurality of electrodes are applied with driving voltages respectively in display, thereby enabling the intensities of deflection electric fields of adjacent liquid crystal deflection regions to be different.

Further, the plurality of electrodes comprise a plurality of point electrodes, each point electrode includes a plurality of sub-electrodes, and the plurality of sub-electrodes are arranged in an approximate circle.

Further, the plurality of electrodes correspond to corresponding liquid crystal deflection regions, each electrode comprises two groups of strip electrodes with extending directions perpendicular to each other and two pieces of planar electrodes, the two groups of strip electrodes are arranged at opposite sides of the liquid crystal layer respectively, and the two pieces of planar electrodes are arranged at opposite sides of the liquid crystal layer respectively.

Further, the liquid crystal cell control module further comprises a signal conversion unit, the signal conversion unit converts the control signal into a driving voltage of each electrode based on the particular region, and outputs the driving voltage to the liquid crystal cell, thereby enabling the light that passes through each liquid crystal deflection region to be emitted to the particular region.

Further, a sub-pixel of the display panel has a rectangle shape.

Further, the width of a sub-pixel of the display panel in a horizontal direction is greater than the width of the sub-pixel in a vertical direction.

Further, the display panel comprises a lens grating and a black matrix, and there is a certain angle between a length direction of the lens grating and an arrangement direction of the black matrix.

Further, a pixel structure of the display panel is a Chinese character “ [symbol] ” shaped structure.

Further, the display unit further comprises a backlight module, the backlight module being used for emitting collimated light, the backlight module comprises:

a light source, a wedge-shaped film, a reflective film and a prism film;

the wedge-shaped film is a polygon wedge-shaped body constituted by a first light entrance surface, a first light exit surface, a second light exit surface, a first wedge-shaped end face and a second wedge-shaped end face, the light source is arranged at a side of the first light entrance surface, the prism film is arranged at a side of the first light exit surface, the reflective film is arranged at a side of the second light exit surface.

Further, the liquid crystal cell comprises a first liquid crystal cell and a second liquid crystal cell superimposed with each other;

the liquid crystal cell control module outputs a control signal of a horizontal direction to the first liquid crystal cell, the first liquid crystal cell controls the light from the display panel that passes through the first liquid crystal cell to be emitted to the particular region along the horizontal direction based on the control signal of the horizontal direction;

the liquid crystal cell control module outputs a control signal of a vertical direction to the second liquid crystal cell, the second liquid crystal cell controls the light from the display panel that passes through the second liquid crystal cell to be emitted to the particular region along the vertical direction based on the control signal of the vertical direction.

Further, the liquid crystal cell control module further comprises a human eye recognition unit, the human eye recognition unit recognizes human eyes from the predetermined human face, determines regions where the left and right eyes of the predetermined human face locate based on positions of the human eyes in the image, and outputs a control signal to the liquid crystal cell based on the regions where the left and right eyes locate, the control signal enables the light from the display panel that passes through the liquid crystal cell to be emitted to the regions where the left and right eyes locate in a time division switching manner.

On the other hand, the embodiment of the present invention further provides a display system control method, comprising the steps of:

capturing an image in front of a display panel;

recognizing a predetermined human face in the image;

adjusting an emission direction of light outputted from the display panel based on a position of the predetermined human face in the image, so as to enable the outputted light to be emitted to a particular region where the predetermined human face locates.

Further, the method further comprises tracing the predetermined human face in real time, and adjusting the emission direction of the light outputted from the display panel based on the position of the predetermined human face.

Further, the step of adjusting the emission direction of the light outputted from the display panel based on the position of the predetermined human face in the image comprises:

arranging a liquid crystal cell in front of the display panel, the liquid crystal cell comprising a plurality of electrodes for deflecting liquid crystals in the liquid crystal cell;

setting a driving voltage of each electrode of the plurality of electrodes based on the position of the predetermined human face, thereby enabling the light from the display panel that passes through the liquid crystal cell to be emitted to the particular region.

Further, the step of adjusting the emission direction of the light outputted from the display panel based on the position of the predetermined human face in the image comprises:

arranging a first liquid crystal cell and a second liquid crystal cell in front of the display panel, the first liquid crystal cell comprising a plurality of electrodes for deflecting liquid crystals in the first liquid crystal cell, the second liquid crystal cell comprising a plurality of electrodes for deflecting liquid crystals in the second liquid crystal cell;

setting a driving voltage of each electrode of the plurality of electrodes of the first liquid crystal cell based on the position of the predetermined human face, thereby enabling the light from the display panel that passes through the first liquid crystal cell to be emitted to the particular region along a horizontal direction;

setting a driving voltage of each electrode of the plurality of electrodes of the second liquid crystal cell based on the position of the predetermined human face, thereby enabling the light from the display panel that passes through the second liquid crystal cell to be emitted to the particular region along a vertical direction.

Further, the step of adjusting the emission direction of the light outputted from the display panel based on the position of the predetermined human face in the image comprises:

arranging a liquid crystal cell in front of the display panel, the liquid crystal cell comprising a plurality of electrodes for deflecting liquid crystals in the liquid crystal cell;

recognizing human eyes from the predetermined human face, determining the regions where the left and right eyes of the predetermined human face locate based on the positions of the human eyes in the image;

setting a driving voltage of each electrode of the plurality of electrodes based on the regions where the left and right eyes locate, thereby enabling the light from the display panel that passes through the liquid crystal cell to be emitted to the regions where the left and right eyes locate in a time division switching manner.

The embodiments of the present invention provide a display system and a control method thereof, the particular region where the predetermined face locates is determined by capturing the image in front of the display unit and recognizing the human face, the direction of the emission light from the display panel that passes through the liquid crystal cell is adjusted so as to enable it to be emitted to the particular region, such that the display image can only be viewed in the particular region where the predetermined human face locates, so as to prevent non-predetermined objects in other regions from peeping.

### BRIEF DESCRIPTION OF DRAWINGS

FIG. 1 is a schematic view of a control structure of a display system according to an embodiment of the present invention.

FIG. 2 is a structural schematic view of a display unit of an embodiment of the present invention.

FIG. 3 is a structural schematic view of a liquid crystal cell of an embodiment of the present invention.

FIG. 4 is a schematic view of an electrode structure of a liquid crystal cell of an embodiment of the present invention.

FIG. 5 is a schematic view of position of a strip electrode of a liquid crystal cell of an embodiment of the present invention.

FIG. 6 is a schematic view of liquid crystal deflection of a liquid crystal cell of an embodiment of the present invention.

FIG. 7 is a schematic view of liquid crystal deflection of a liquid crystal cell of an embodiment of the present invention.

FIG. 8 is a structural schematic view of a control module of a liquid crystal cell of an embodiment of the present invention.

FIG. 9 is a schematic view of an assembly structure of a display unit of an embodiment of the present invention.

FIG. 10 is a structural schematic view of a backlight of an embodiment of the present invention.

FIG. 11 is a schematic view of a wedge-shaped structure of a backlight of an embodiment of the present invention.

FIG. 12 is a structural schematic view of a prism film of a backlight of an embodiment of the present invention.

FIG. 13 is a schematic view of a black matrix and a grating structure of an embodiment of the present invention.

FIG. 14 is a structural schematic view of a sub-pixel of an embodiment of the present invention.

FIG. 15 is a structural schematic view of a pixel unit of an embodiment of the present invention.

FIG. 16 is a schematic view of a control structure of a display system of an embodiment of the present invention.

FIG. 17 is a schematic view of an electrode structure of a display system of an embodiment of the present invention.

FIG. 18 is a structural schematic view of a point electrode of a display system of an embodiment of the present invention.

FIG. 19 is a schematic view of a control structure of a display system of an embodiment 4 of the present invention.

FIG. 20 is a schematic view of flow of a display system control method of an embodiment of the present invention.

FIG. 21 is a structural schematic view of a display system of an embodiment of the present invention.

FIG. 22 is a schematic view of close range emission of the light that passes through the liquid crystal cell according to an embodiment of the present invention.

FIG. 23 is a schematic view of long range emission of the light that passes through the liquid crystal cell according to an embodiment of the present invention.

FIG. 24 is a schematic view of side emission of the light that passes through the liquid crystal cell according to an embodiment of the present invention.

### DETAILED DESCRIPTION OF THE INVENTION

The specific implementing modes of the present invention will be further described in detail combined with the drawings and the embodiments. The following embodiments are used for explaining the present invention, but not for limiting the scope of the present invention.

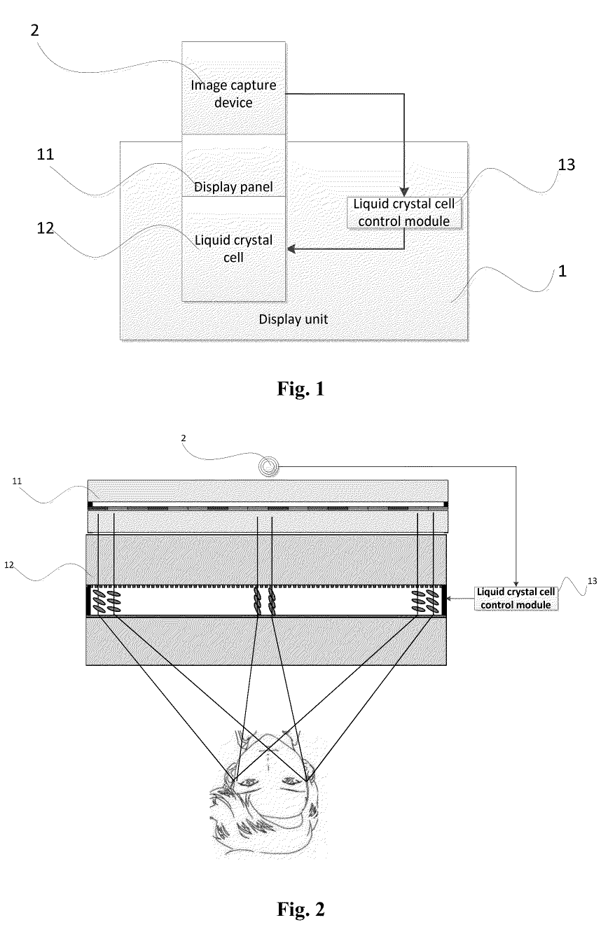

As shown in FIG. 1, the present invention provides a display system, the display system comprising: a display unit 1 and an image capture device 2. The display unit 1 includes a display panel 11 and a liquid crystal cell 12 arranged in light exit direction of the display panel. The display unit 1 further includes a liquid crystal cell control module 13. The image capture device 2 acquires an image in front of the display unit 1 and transmits it to the liquid crystal cell control module 13. The liquid crystal cell control module 13 may recognize a predetermined human face in the image, determine a particular region where the predetermined human face is viewing based on a position of the predetermined human face in the image, and outputs a control signal to the liquid crystal cell 12 based on the particular region. The liquid crystal cell 12 controls light from the display panel 11 that passes through the liquid crystal cell 12 to be emitted to the particular region based on the control signal. Next, the display system provided by embodiments of the present invention will be explained in detail.

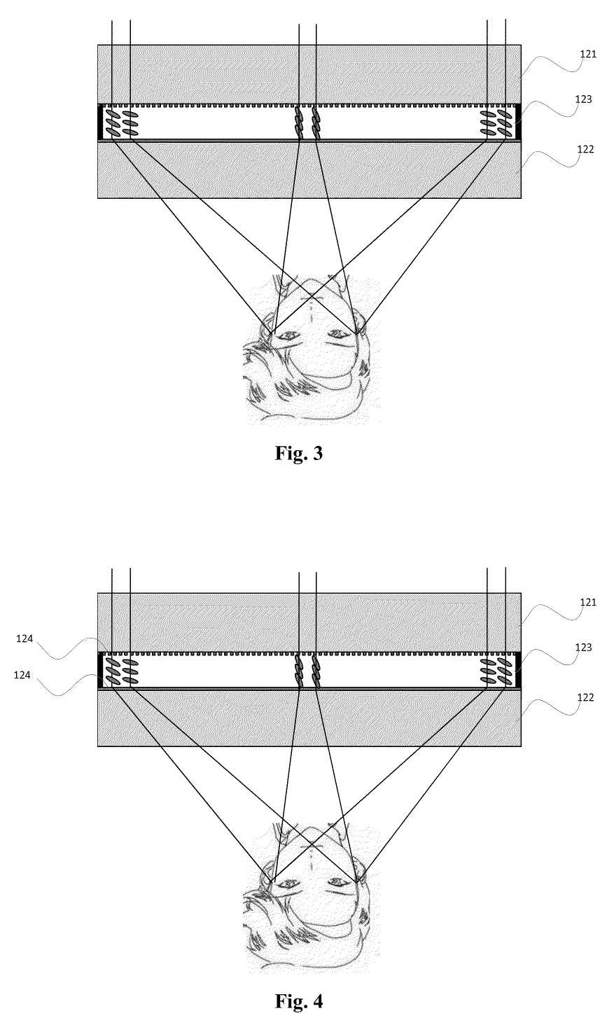

As shown in FIG. 2 and FIG. 3, the liquid crystal cell 12 comprises: a first substrate 121, a second substrate 122, and a liquid crystal layer 123 located between the first substrate and the second substrate. The liquid crystal layer 123 comprises a plurality of liquid crystal deflection regions. Liquid crystal molecules of each liquid crystal deflection region are deflected in display, and the liquid crystal molecules of adjacent liquid crystal deflection regions are deflected in different angles, thereby enabling the light that passes through each liquid crystal deflection region to be emitted to the particular region.

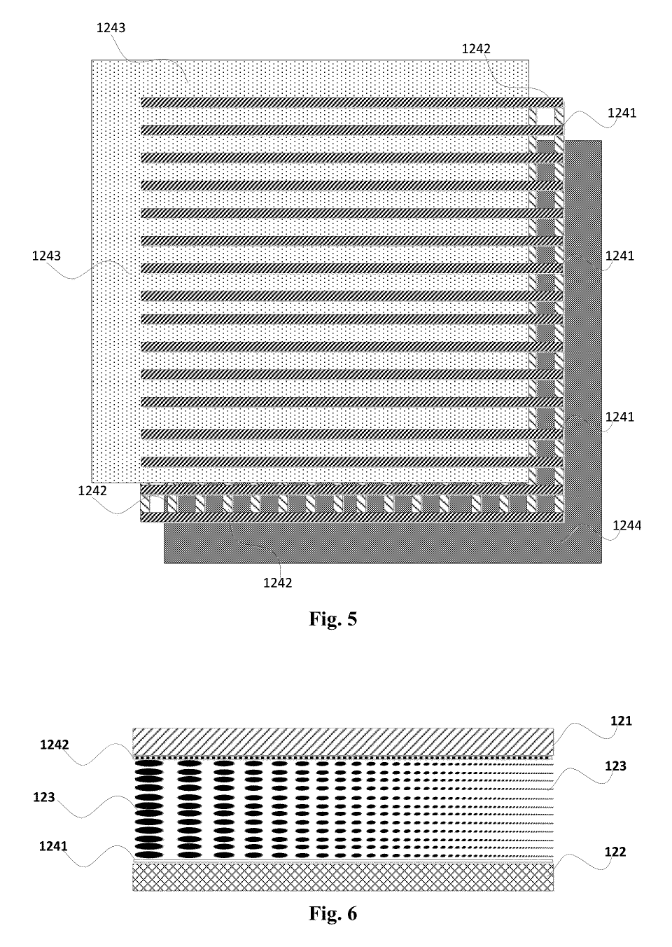

As shown in FIG. 4, the liquid crystal cell 12 may include a plurality of electrodes 124 arranged on the first substrate 121 and/or the second substrate 122. The plurality of electrodes 124 are applied with driving voltages respectively in display, thereby enabling the intensities of deflection electric fields of adjacent liquid crystal deflection regions to be different. As shown in FIG. 5, each electrode in the plurality of electrodes 124 corresponds to a pixel region, the electrode corresponding to each pixel region comprises two groups of strip electrodes (1241 and 1242) with extending directions perpendicular to each other and corresponding planar electrodes (1243 and 1244). The two groups of strip electrodes 1241 and 1242 are arranged at opposite sides of the liquid crystal layer 123 respectively, and the two pieces of planar electrodes 1243, 1244 are arranged at opposite sides of the liquid crystal layer 123 respectively. Here, the positions of the two groups of strip electrodes 1241 and 1242 and the corresponding planar electrodes 1243 and 1244 can be set based on actual requirements. For example, the planar electrodes 1243 and 1244 can be arranged at the outer sides of the two groups of strip electrodes 1241 and 1242 respectively, and can also be arranged between the two groups of strip electrodes. Furthermore, one of the planar electrodes can also be arranged between the two groups of strip electrodes. All the planar electrodes at the same side of the liquid crystal layer can form an integral planar electrode. In one embodiment, a corresponding electric field is generated by cooperation of the strip electrodes and the planar electrodes, the corresponding electric field can accurately control the liquid crystal molecules in each deflection region to be deflected laterally and/or longitudinally according to the corresponding control signal, so as to enable the light that passes through each liquid crystal deflection region to be emitted to the particular region accurately. It should be understood that the liquid crystal deflection region here can be a block region, thus, the above two groups of strip electrodes with the extending directions perpendicular to each other and the corresponding planar electrodes are required to adjust the voltage of each pixel region. Certainly, it can also be achieved by corresponding block electrodes, here left, right, top and bottom boundaries of the particular region are all limited.

As shown in FIG. 6 and FIG. 7, in display, the liquid crystal molecules of each liquid crystal deflection region in the liquid crystal layer 123 located between the first substrate 121 and the second substrate 122 are deflected based on the control signal through the voltage applied by the electrodes. The deflection angles of the liquid crystal molecules of adjacent liquid crystal deflection regions are different, thereby enabling the liquid crystal molecules in the liquid crystal layer to form a lens. The light that passes through the lens is refracted, thereby enabling the light that passes through each liquid crystal deflection region to be emitted to the predetermined region.

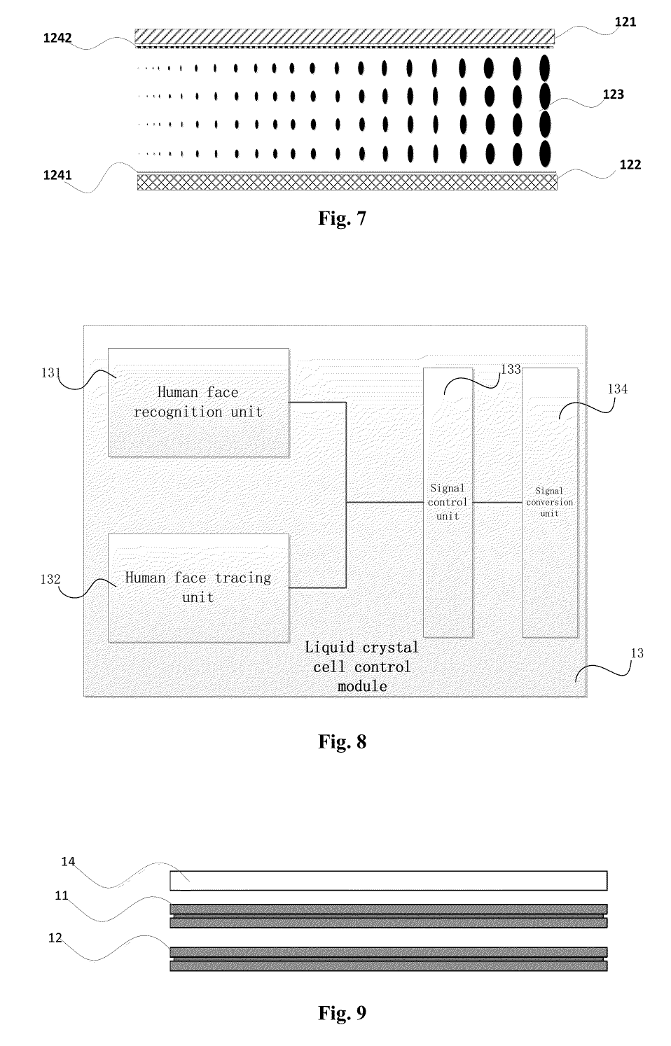

As shown in FIG. 8, the liquid crystal cell control module 13 comprises: a human face recognition unit 131, a human face tracing unit 132, a signal control unit 133, and a signal conversion unit 134. The human face recognition unit 131 receives the image information transmitted by the image capture device 2 in real time and recognizes the predetermined human face in the image in real time. The human face recognition unit transmits the position information of the predetermined human face recognized in the image to the signal control unit 133 and the human face tracing unit 132. In an embodiment of the present invention, the method of recognizing the human face adopted by the human face recognition unit 131 is a relatively mature face recognition method. For example, facial features of a particular person are pre-stored in the human face recognition unit. The human face recognition unit then recognizes the human face in the image firstly, then extracts the facial features of this human face, and compares them with the pre-stored facial features to determine whether it is the face of the particular person. Of course, the present invention is not limited to this.

In order to enable the light that passes through the liquid crystal cell 12 to be emitted to the predetermined person in real time, so as to improve user experience, the human face tracing unit 132 traces the predetermined human face recognized in the image information transmitted by the image capture device 2 in real time, determines the particular region where the predetermined human face locates based on the position of the predetermined human face in the image, and outputs the front, the back, the left and the right coordinates that locate the human face to the signal control unit 133 in real time. The front, the back, the left and the right coordinates of the human face can be obtained based on some existing human facial recognition methods, which will not be repeated here one by one. The signal control unit 133 adjusts the outputted control signal in real time based on the front, the back, the left and the right coordinates of the human face.

The human face tracing unit 132 can locate the human eyes optionally when tracing the human face in the image. After locating the human eyes, the light that passes through the liquid crystal cell 12 can be emitted to the eye range of the predetermined person in real time, which does not exceed the head. Thus, information leakage can be prevented with better accuracy. In an embodiment of the present invention, the human face tracing method adopted by the human face tracing unit 132 is a relatively mature human face tracing method. The signal control unit 133 determines a particular region based on the predetermined human face recognized in the image information (and the front, the back, the left and the right coordinates that locate the human face), and generates a corresponding control signal according to the particular region, which is outputted to the signal conversion unit 134. The signal conversion unit 134 converts the control signal into a driving voltage of each electrode, and outputs it to the liquid crystal cell 12 The liquid crystal cell 12 controls the light from the display panel 11 that passes through the liquid crystal cell 12 to be emitted to the particular region where the human face of the predetermined person locates based on the control signal, thereby, the display image can only be viewed by the predetermined person generally.

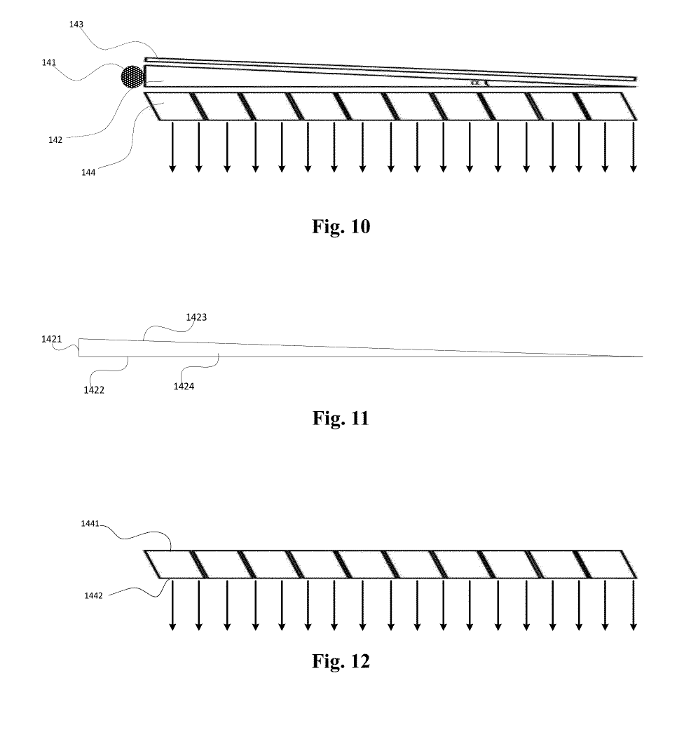

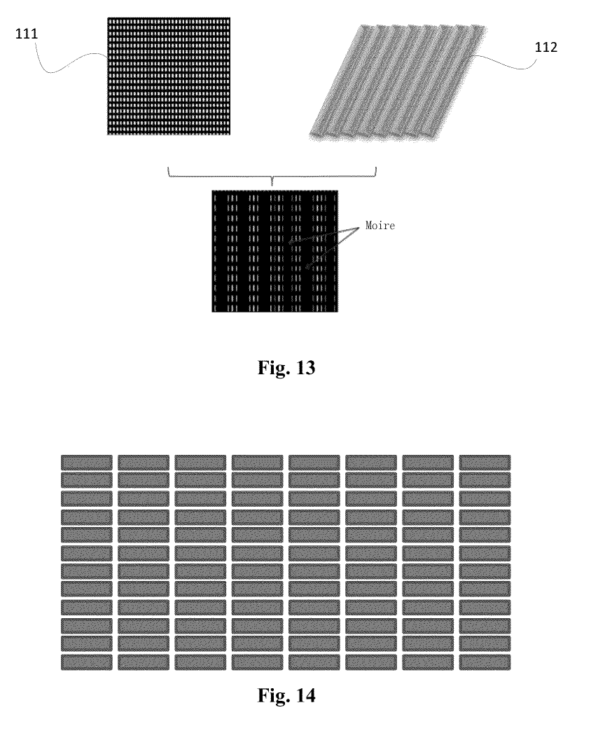

As shown in FIG. 9, the display unit further comprises a backlight module 14. The backlight module 14 is used for emitting collimated light. As shown in FIG. 10, the backlight module comprises: a light source 141, a wedge-shaped film 142, a reflective film 143 and a prism film 144. The light source optionally may be an LED light source. As shown in FIG. 11, the wedge-shaped film is a polygon wedge-shaped body constituted by a first light entrance surface 1421, a first light exit surface 1422, a second light exit surface 1423, a first wedge-shaped end face 1424 and a second wedge-shaped end face (not shown in the figure). The first light entrance surface 1421 is arranged at the thickest end of the wedge-shaped film 142.

As shown in FIG. 10, the light source 141 is arranged at a side of the first light entrance surface 1421 and the light source 141 is arranged close to the first light entrance surface. The reflective film 143 is arranged at a side of the second light exit surface 1423 and the reflective surface of the reflective film 143 is close to the second light exit surface 1423. The reflective surface of the reflective film 143 may reflect the light emitted by the second light exit surface 1423 back to the wedge-shaped film 142 for recycling.

As shown in FIG. 10 and FIG. 12, the prism film 144 is arranged at a side of the first light exit surface 1422. The prism film 144 is an array of parallelogram bodies arranged successively along the normal direction of the first light entrance surface 1421. Because the sectional plane of the parallelogram body is a parallelogram, the prism film 144 comprises a second light entrance surface 1441 and a third light exit surface 1442 parallel with each other and the second light entrance surface 1441 is parallel with the first light exit surface 1422. The light emitted by the first light exit surface 1422 enters the prism film 144 from the second light entrance 1441 and the prism film 144 refracts the parallel light beams emitted by the first light exit surface 1422 of the wedge-shaped film 142 in a relatively large incident angle with the second light entrance surface 1441 into parallel light beams perpendicular to the third light exit surface 1442 for emission.

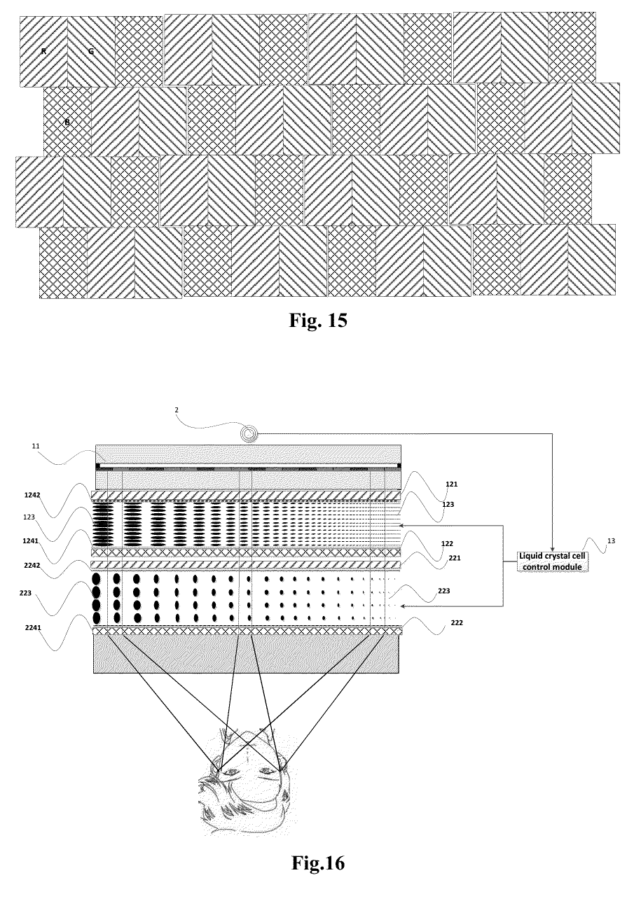

In an embodiment of the present invention, the display panel 11 may be a liquid crystal display (LCD), a digital information display (DID), an organic light-emitting diode (OLED), etc. In an ordinary display panel, after the black matrix and the lens grating are placed together, due to the amplification function of the lens grating, the black matrix will be amplified, which is presented as uniform black lines (moirè) on the whole. In order to avoid such a problem, as shown in FIG. 14, a shape of a sub-pixel of the display panel optionally may be a regular rectangle. When the sub-pixel has a rectangle shape, the moire generated is mitigated. In order to weaken the moirè further, there is a certain angle between the length direction of the lens grating 112 and the arrangement direction of the black matrix 111. As shown in FIG. 14, the inventor finds in the experiments that the moirè is mitigated when the width of the sub-pixel in the horizontal direction is greater than the width of the sub-pixel in the vertical direction. When the pixel structure of the display panel 11 is a Chinese character “ [symbol] ” shaped structure (i.e., wherein rows are staggered such that pixels are not vertically aligned), the edge of the black matrix is not a horizontal or vertical regular straight line, and the moirè is weakened under the effect of the lens grating. As shown in FIG. 15, the moirè can be mitigated obviously when the pixel structure of the display panel 11 is a Chinese character “ [symbol] ” shaped structure. The present invention not only can mitigate the moirè through any of the above several manners, but also can mitigate the moiré through superposition of the several manners, thereby optimizing the display effect and improve user experience.

In some embodiments, it may be relatively difficult to control the two groups of strip electrodes 1241 and 1242 arranged on the first substrate 121 and/or the second substrate 122 with the extending directions perpendicular with each other in display. Therefore, according to another embodiment of the present invention, the control difficulty to the electrode can be reduced by arranging two layers of liquid crystal cells in front of the display panel 11. Specifically, as shown in FIG. 16, a first liquid crystal cell that controls emission of light in the horizontal direction and a second liquid crystal cell that controls emission of light in the vertical direction are arranged in front of the display panel respectively. The display unit 1 further comprises a liquid crystal cell control module 13. The image capture device 2 captures the image in front of the display unit 1 and transmits it to the liquid crystal cell control module 13. The liquid crystal cell control module 13 recognizes a predetermined human face in the image, determines a particular region based on the position of the predetermined human face in the image, and outputs a control signal to the first liquid crystal cell and the second liquid crystal cell based on the particular region. The first liquid crystal cell and the second liquid crystal cell enables the light that passes through the first liquid crystal cell and the second liquid crystal cell to be emitted to the particular region based on the control signal.

As shown in FIG. 16, the first liquid crystal cell comprises: a first substrate 121, a second substrate 122, and a liquid crystal layer 123 located between the first substrate 121 and the second substrate 122. The liquid crystal layer 123 comprises a plurality of liquid crystal deflection regions. Liquid crystal molecules of each liquid crystal deflection region are deflected in display and the liquid crystal molecules of adjacent liquid crystal deflection regions are deflected in different angles, thereby enabling the light that passes through each liquid crystal deflection region to be emitted to the particular region along the horizontal direction. As shown in FIG. 16, the first liquid crystal cell further comprises: a plurality of electrodes arranged on the first substrate 121 and/or the second substrate 122. The plurality of electrodes are applied with driving voltages respectively in display, thereby enabling the intensities of deflection electric fields of adjacent liquid crystal deflection regions to be different. In the electrodes arranged on the first substrate 121 and the second substrate 122, the electrode on at least one of the substrates is a strip electrode 1242, the corresponding electrode arranged on the other substrate optionally may be a planar electrode 1241.

As shown in FIG. 16, the second liquid crystal cell comprises: a third substrate 221, a fourth substrate 222, and a liquid crystal layer 223 located between the third substrate 221 and the fourth substrate 222. The liquid crystal layer 223 comprises a plurality of liquid crystal deflection regions. Liquid crystal molecules of each liquid crystal deflection region are deflected in display, and the liquid crystal molecules of adjacent liquid crystal deflection regions are deflected in different angles, thereby enabling the light that passes through each liquid crystal deflection region to be emitted to the particular region along the vertical direction. As shown in FIG. 16, the second liquid crystal cell further comprises: a plurality of electrodes arranged on the third substrate 221 and/or the fourth substrate 222. The plurality of electrodes are applied with driving voltages respectively in display, thereby enabling the intensities of deflection electric fields of adjacent liquid crystal deflection regions to be different. In the electrodes arranged on the third substrate 221 and the fourth substrate 222, the electrode on at least one of the substrates is a strip electrode 2242, and the corresponding electrode arranged on the other substrate optionally may be a planar electrode 2241.

Of course, it can be understood that the present invention is not limited to this. The positions of the first liquid crystal cell and the second liquid crystal cell in this embodiment can be interchanged. In this embodiment, the light that passes through the first liquid crystal cell and the second liquid crystal cell is emitted to the particular region through cooperation of the first liquid crystal cell and the second liquid crystal cell, the technical solution provided by this embodiment can reduce the control difficulty of the electrode effectively.

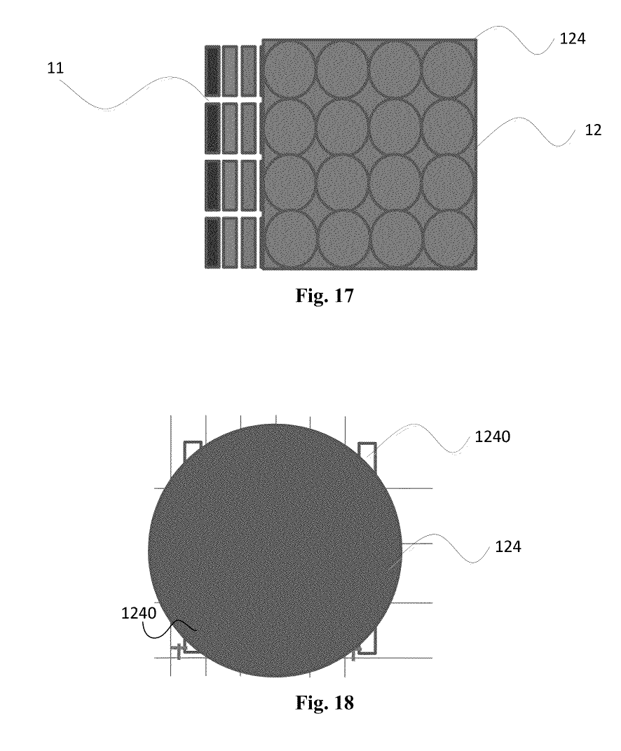

In some embodiments, the plurality of electrodes arranged on the first substrate 121 and/or the second substrate 122 are point electrodes 124, as shown in FIG. 17. As shown in FIG. 18, each point electrode 124 comprises a plurality of sub-electrodes 1240. Each sub-electrode 1240 of each point electrode 124 is applied with a driving voltage respectively in display, thereby enabling the intensities of deflection electric fields of adjacent liquid crystal deflection regions to be different. In this embodiment, the point electrode 124 can accurately control the liquid crystal molecules in each deflection region to be deflected laterally and/or longitudinally according to the corresponding control signal, so as to enable the light that passes through each liquid crystal deflection region to be emitted to the particular region accurately.

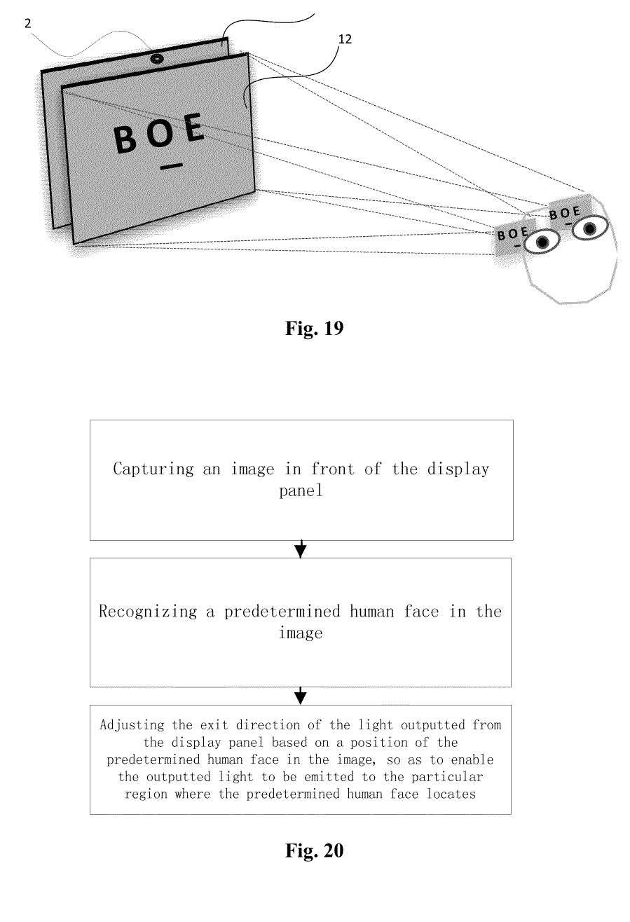

In some embodiments, the liquid crystal cell control module 13 further comprises a human eye recognition unit. The human eye recognition unit recognizes the human eyes from the predetermined human face, determines the regions where the left and right eyes of the predetermined human face locate based on the position of the human eyes in the image, and outputs a control signal to the liquid crystal cell 12 based on the regions where the left and right eyes locate. The control signal enables the light from the display panel 11 that passes through the liquid crystal cell 12 to be emitted to the regions where the left and right eyes locate in a time division switching manner. Specifically, the liquid crystal cell control module 13 recognizes the predetermined human face in the image, and further recognizes the human eyes. The liquid crystal cell control module 13 then determines a particular region based on the position of the human eyes of the predetermined human face in the image and outputs a control signal to the liquid crystal cell 12 based on the particular region. The liquid crystal cell 12 enables the light that passes through the liquid crystal cell 12 to be emitted to the particular region based on the control signal. The human eye recognition method adopts a relatively mature eyeball recognition method, which will not be repeated here. As shown in FIG. 19, when the liquid crystal cell control module 13 outputs the control signal to the liquid crystal cell, the left and right eye images are switched in a time division manner. The light that passes through the liquid crystal cell is emitted to the left eye at the first moment and the light that passes through the liquid crystal cell is emitted to the right eye at the second moment. Through time division switching of the left and right eyes, the visual range of the image is further narrowed to the human eyes, which improves the anti-view effect for the non-predetermined objects in other regions. In order to improve user experience further, the refresh frequencies of the display panel 11 of the display unit 1 and the liquid crystal cell 12 arranged in the light exit direction of the display panel are set above 120 hz. In the case that the refresh frequencies of the display panel 11 of the display unit 1 and the liquid crystal cell 12 arranged in the light exit direction of the display panel are set above 120 hz, after the liquid crystal cell control module 13 outputs the control signal which enables the left and right eye images to be switched in a time division manner to the liquid crystal cell, the left and right eyes of the predetermined person see the images that are switched in a time division manner, without feeling the flicker phenomenon, which improves user experience further.

An embodiment of the present invention further provides a control method of the above display system. As shown in FIG. 20, the method comprises the following steps: capturing an image in front of the display panel, recognizing a predetermined human face in the image, and adjusting an emission direction of light outputted from the display panel based on a position of the predetermined human face in the image, so as to enable the outputted light to be emitted to a particular region where the predetermined human face locates. Next, the display system control method provided by the present invention will be explained in detail.

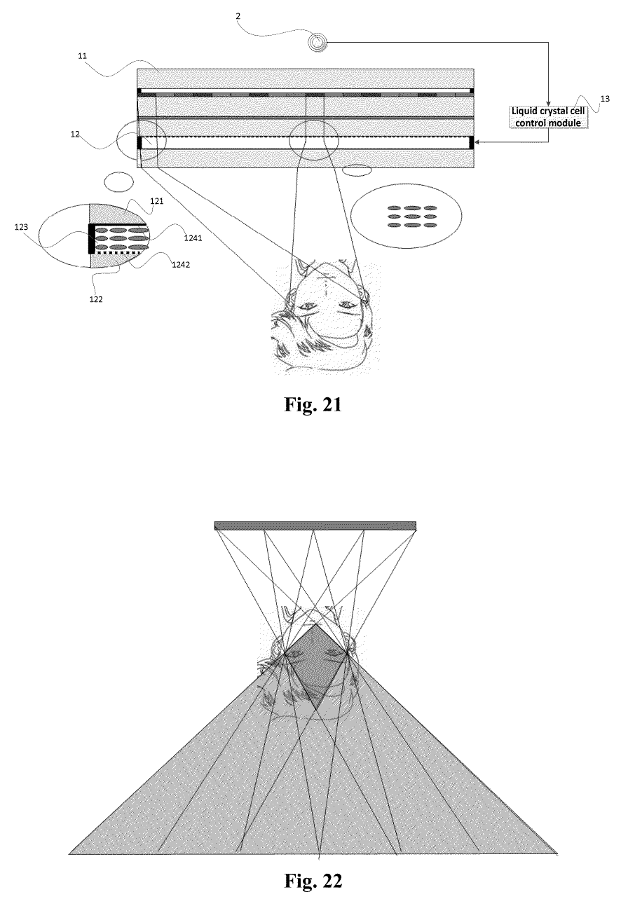

First, an image in front of the display panel is captured. As shown in FIG. 21, in the present invention, the image capture device captures the image information in front of the display panel in real time, and the image capture device transmits the captured image information to the liquid crystal cell control module in real time.

Secondly, the predetermined human face in the image is recognized. The liquid crystal cell control module processes the image information after receiving the image information transmitted by the image capture device in real time, and generates a control signal based on the predetermined human face information in the image information, which is transmitted to the liquid crystal cell. Specifically, the human face recognition unit of the liquid crystal cell control module receives the image information from the image capture device in real time, recognizes the predetermined human face in the image in real time, and transmits the position information of the predetermined human face in the image to the signal control unit and the human face tracing unit of the liquid crystal cell control module. In an embodiment of the present invention, the human face recognition method adopted by the human face recognition unit is a relatively mature face recognition method. In order to enable the light that passes through the liquid crystal cell to be emitted to the predetermined person, the human face tracing unit of the liquid crystal cell control module traces the predetermined human face recognized in the image information of the image capture device in real time, and outputs the front, the back, the left and the right coordinates that locate the human face to the signal control unit in real time, so as to improve user experience. When tracing the human face in the image, optionally the human eyes can be located. After the human eyes are located, the light that passes through the liquid crystal cell can be emitted to the human eye range of the predetermined person, which does not exceed the head. Thus, the information leakage can be prevented better. In one embodiment, the human face tracing method adopted by the human face tracing unit is a relatively mature human face tracing method.

Finally, an emission direction of light outputted from the display panel based on a position of the predetermined human face in the image, so as to enable the outputted light to be emitted to a particular region where the predetermined human face locates is adjusted. The signal control unit of the liquid crystal cell control module determines a particular region based on the predetermined human face recognized in the image information (and the front, the back, the left and the right coordinates that locate the human face), and generates according to the particular region a corresponding control signal which is outputted to the signal conversion unit. The signal conversion unit of the liquid crystal cell control module converts the control signal into a driving voltage of each electrode, which is outputted to the liquid crystal cell, thereby enabling the light that passes through each liquid crystal deflection region to be emitted to the particular region. Specifically, the signal conversion unit set the driving voltage of each electrode based on the received control signal, thereby enabling the light that passes through each liquid crystal deflection region to be emitted to the particular region. In some embodiments, the predetermined human face is traced in real time, and the emission direction of the light outputted from the display panel is adjusted based on the position of the predetermined human face in real time. The real time manner enables the light exit direction of the display panel to be changed timely, which ensures that the predetermined person can have an optimal viewing range.

In some embodiments, a liquid crystal cell that controls emission of light in the horizontal direction and a liquid crystal cell that controls emission of light in the vertical direction are arranged in front of the display panel respectively. More specifically, a first liquid crystal cell and a second liquid crystal cell are arranged in front of the display panel. The first liquid crystal cell comprises a plurality of electrodes for deflecting liquid crystals of the first liquid crystal cell and the second liquid crystal cell comprising a plurality of electrodes for deflecting liquid crystals of the second liquid crystal cell. A driving voltage of each electrode of the first liquid crystal cell is set based on the position where the predetermined human face is located, thereby enabling the light from the display panel that passes through the first liquid crystal cell to be emitted to the particular region along the horizontal direction. A driving voltage of each electrode of the second liquid crystal cell is set based on the position where the predetermined human face is located, thereby enabling the light from the display panel that passes through the second liquid crystal cell to be emitted to the particular region along the vertical direction.

In some embodiments, the light that passes through the first liquid crystal cell and the second liquid crystal cell is emitted to the particular region through cooperation of the first liquid crystal cell and the second liquid crystal cell, thus reducing the control difficulty of the electrode effectively.

In some embodiments, the plurality of electrodes are arranged on the first substrate 121 and/or the second substrate 122 are point electrodes 124 as shown in FIG. 17. As shown in FIG. 18, each point electrode 124 comprises a plurality of sub-electrodes 1240, and each sub-electrode 1240 of each point electrode 124 is applied with a driving voltage respectively in display, thereby enabling the intensities of deflection electric fields of adjacent liquid crystal deflection regions to be different. In this embodiment, the point electrode 124 can accurately control the liquid crystal molecules in each deflection region to be deflected laterally and/or longitudinally according to the corresponding control signal, so as to enable the light that passes through each liquid crystal deflection region to be emitted to the particular region accurately.

In some embodiments, the liquid crystal cell control module 13 further comprises a human eye recognition unit. The human eye recognition unit recognizes the human eyes from the predetermined human face, determines the regions where the left and right eyes of the predetermined human face locate based on the position of the human eyes in the image, and outputs a control signal to the liquid crystal cell 12 based on the regions where the left and right eyes are located. The control signal enables the light from the display panel 11 that passes through the liquid crystal cell 12 to be emitted to the regions where the left and right eyes locate in a time division switching manner. Through time division switching of the left and right eyes, the visual range of the image is further narrowed to the human eyes, which improves the anti-view effect for the non-predetermined objects in other regions.

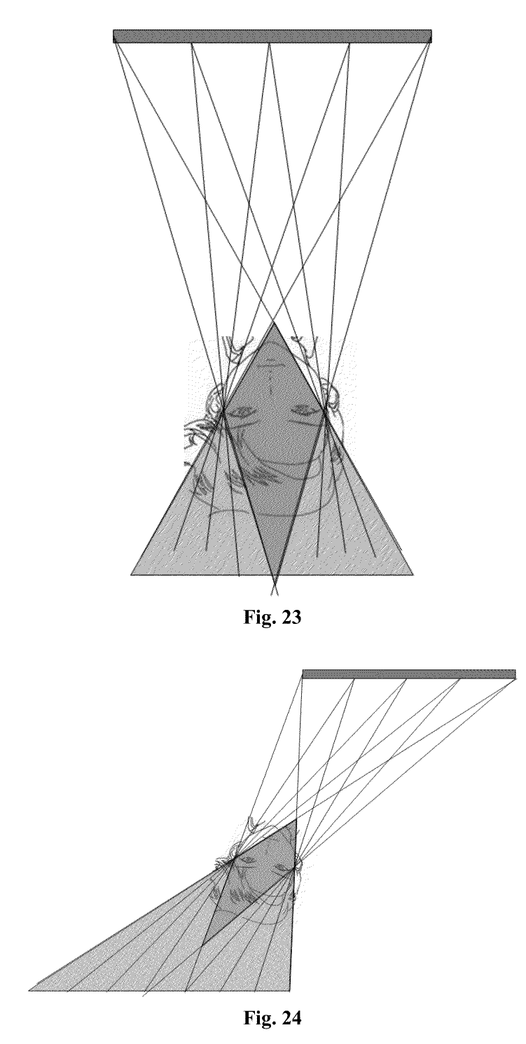

To sum up, the display system and the control method thereof provided by the present invention, by capturing the image in front of the display unit, recognizing the human face so as to determine the particular region where the predetermined human face locates, and adjusting the direction of the emitted light that passes through the liquid crystal cell. Doing so enables light to be emitted to the particular region, enabling the display image to be viewed only by the particular region where the predetermined human face is located, so as to prevent non-predetermined objects in other regions from peeping. As shown in FIGS. 22-24, the present invention can adjust the direction of the emitted light that passes through the liquid crystal cell dynamically when the predetermined person moves freely in real time within various viewing ranges such as close range, long range, and side range, so as to enable the predetermined person to have an optimal viewing range. The present invention improves user experience while preventing information leakage.

The above embodiments are only used for explaining the present invention rather than limitations to the present invention. The ordinary skilled person in the related technical field can also make various modifications and variants without departing from the spirit and scope of the present invention. Therefore, all the equivalent technical solutions also belong to the category of the present invention, the patent protection scope of the present invention should be defined by the claims.

1. A display system comprising:
a display unit, the display unit comprising: a display panel, a liquid crystal cell arranged in light exit direction of the display panel and a liquid crystal cell control module; and
an image capture device, the image capture device acquiring an image in front of the display unit and transmitting the image to the liquid crystal cell control module,
wherein the liquid crystal cell control module recognizes a predetermined human face in the image, determines a particular region where the predetermined human face locates based on a position of the predetermined human face in the image, and outputs a control signal to the liquid crystal cell based on the particular region,
wherein the liquid crystal cell controls light from the display panel that passes through the liquid crystal cell based on the control signal, so as to enable the light to be emitted to the particular region.

2. The display system of claim 1, wherein the liquid crystal cell comprises:
a first substrate, a second substrate and a liquid crystal layer located between the first substrate and the second substrate,
wherein the liquid crystal layer comprises a plurality of liquid crystal deflection regions, liquid crystal molecules of each liquid crystal deflection region are deflected based on the control signal in display, and the liquid crystal molecules of adjacent liquid crystal deflection regions are deflected in different angles, thereby enabling the light that passes through each liquid crystal deflection region to be emitted to the particular region.

3. The display system of claim 2, wherein the liquid crystal cell further comprises: a plurality of electrodes arranged on the first substrate and/or the second substrate, the plurality of electrodes are applied with driving voltages respectively in display, thereby enabling the intensities of deflection electric fields of adjacent liquid crystal deflection regions to be different.

4. The display system of claim 3, wherein the plurality of electrodes comprise a plurality of point electrodes, each point electrode includes a plurality of sub-electrodes, and the plurality of sub-electrodes are arranged in an approximate circle.

5. The display system of claim 3, wherein the plurality of electrodes correspond to corresponding liquid crystal deflection regions, each electrode comprises two groups of strip electrodes with extending directions perpendicular to each other and two pieces of planar electrodes; and
Wherein the two groups of strip electrodes are arranged at opposite sides of the liquid crystal layer respectively, and the two pieces of planar electrodes are arranged at opposite sides of the liquid crystal layer respectively.

6. The display system of claim 5, wherein the liquid crystal cell control module further comprises: a signal conversion unit, the signal conversion unit converts the control signal into a driving voltage of each electrode based on the particular region, and outputs the driving voltage to the liquid crystal cell, thereby enabling the light that passes through each liquid crystal deflection region to be emitted to the particular region.

7. The display system of claim 1, wherein a sub-pixel of the display panel has a rectangle shape.

8. The display system of claim 1, wherein the width of a sub-pixel of the display panel in a horizontal direction is greater than the width of the sub-pixel in a vertical direction.

9. The display system of claim 1, wherein the display panel comprises a lens grating and a black matrix, and there is a certain angle between a length direction of the lens grating and an arrangement direction of the black matrix.

10. The display system of claim 1, wherein a pixel structure of the display panel is a Chinese character “ [symbol] ” shaped structure.

11. The display system of claim 1, wherein the display unit further comprises a backlight module, the backlight module being used for emitting collimated light, the backlight module comprises:
a light source, a wedge-shaped film, a reflective film and a prism film;
wherein the wedge-shaped film is a polygon wedge-shaped body constituted by a first light entrance surface, a first light exit surface, a second light exit surface, a first wedge-shaped end face and a second wedge-shaped end face, the light source is arranged at a side of the first light entrance surface, the prism film is arranged at a side of the first light exit surface, the reflective film is arranged at a side of the second light exit surface.

12. The display system of claim 1, wherein the liquid crystal cell comprises a first liquid crystal cell and a second liquid crystal cell superimposed with each other;
wherein the liquid crystal cell control module outputs a control signal of a horizontal direction to the first liquid crystal cell, the first liquid crystal cell controls the light from the display panel that passes through the first liquid crystal cell to be emitted to the particular region along the horizontal direction based on the control signal of the horizontal direction; and
wherein the liquid crystal cell control module outputs a control signal of a vertical direction to the second liquid crystal cell, the second liquid crystal cell controls the light from the display panel that passes through the second liquid crystal cell to be emitted to the particular region along the vertical direction based on the control signal of the vertical direction.

13. The display system as claimed in claim 1, wherein the liquid crystal cell control module further comprises a human eye recognition unit, the human eye recognition unit recognizes human eyes from the predetermined human face, determines regions where the left and right eyes of the predetermined human face locate based on positions of the human eyes in the image, and outputs a control signal to the liquid crystal cell based on the regions where the left and right eyes locate, the control signal enables the light from the display panel that passes through the liquid crystal cell to be emitted to the regions where the left and right eyes locate in a time division switching manner.

14. A display system control method, comprising the steps of:
capturing an image in front of a display panel;
recognizing a predetermined human face in the image; and
adjusting an emission direction of light outputted from the display panel based on a position of the predetermined human face in the image, so as to enable the outputted light to be emitted to a particular region where the predetermined human face locates.

15. The display system control method of claim 14, further comprising:
tracing the predetermined human face in real time; and
adjusting the emission direction of the light outputted from the display panel based on the position of the predetermined human face.

16. The display system control method of claim 14, wherein the step of adjusting the emission direction of the light outputted from the display panel based on the position of the predetermined human face in the image comprises:
arranging a liquid crystal cell in front of the display panel, the liquid crystal cell comprising a plurality of electrodes for deflecting liquid crystals in the liquid crystal cell; and
setting a driving voltage of each electrode of the plurality of electrodes based on the position of the predetermined human face, thereby enabling the light from the display panel that passes through the liquid crystal cell to be emitted to the particular region.

17. The display system control method of claim 15, wherein the step of adjusting the emission direction of the light outputted from the display panel based on the position of the predetermined human face in the image comprises:
arranging a liquid crystal cell in front of the display panel, the liquid crystal cell comprising a plurality of electrodes for deflecting liquid crystals in the liquid crystal cell; and
setting a driving voltage of each electrode of the plurality of electrodes based on the position of the predetermined human face, thereby enabling the light from the display panel that passes through the liquid crystal cell to be emitted to the particular region.

18. The display system control method of claim 14, wherein the step of adjusting the emission direction of the light outputted from the display panel based on the position of the predetermined human face in the image comprises:
arranging a first liquid crystal cell and a second liquid crystal cell in front of the display panel, the first liquid crystal cell comprising a plurality of electrodes for deflecting liquid crystals in the first liquid crystal cell, the second liquid crystal cell comprising a plurality of electrodes for deflecting liquid crystals in the second liquid crystal cell;
setting a driving voltage of each electrode of the plurality of electrodes of the first liquid crystal cell based on the position of the predetermined human face, thereby enabling the light from the display panel that passes through the first liquid crystal cell to be emitted to the particular region along a horizontal direction; and
setting a driving voltage of each electrode of the plurality of electrodes of the second liquid crystal cell based on the position of the predetermined human face, thereby enabling the light from the display panel that passes through the second liquid crystal cell to be emitted to the particular region along a vertical direction.

19. The display system control method of claim 15, wherein the step of adjusting the emission direction of the light outputted from the display panel based on the position of the predetermined human face in the image comprises:
arranging a first liquid crystal cell and a second liquid crystal cell in front of the display panel, the first liquid crystal cell comprising a plurality of electrodes for deflecting liquid crystals in the first liquid crystal cell, the second liquid crystal cell comprising a plurality of electrodes for deflecting liquid crystals in the second liquid crystal cell;
setting a driving voltage of each electrode of the plurality of electrodes of the first liquid crystal cell based on the position of the predetermined human face, thereby enabling the light from the display panel that passes through the first liquid crystal cell to be emitted to the particular region along a horizontal direction; and
setting a driving voltage of each electrode of the plurality of electrodes of the second liquid crystal cell based on the position of the predetermined human face, thereby enabling the light from the display panel that passes through the second liquid crystal cell to be emitted to the particular region along a vertical direction.

20. The display system control method of claim 14, wherein the step of adjusting the emission direction of the light outputted from the display panel based on the position of the predetermined human face in the image comprises:
arranging a liquid crystal cell in front of the display panel, the liquid crystal cell comprising a plurality of electrodes for deflecting liquid crystals in the liquid crystal cell;
recognizing human eyes from the predetermined human face, determining the regions where the left and right eyes of the predetermined human face locate based on the positions of the human eyes in the image; and
setting a driving voltage of each electrode of the plurality of electrodes based on the regions where the left and right eyes locate, thereby enabling the light from the display panel that passes through the liquid crystal cell to be emitted to the regions where the left and right eyes locate in a time division switching manner.
